(19) United States
(12) Patent Application Publication
(10) Pub. No.: US 2019/0049898 A1
(43) Pub. Date: Feb. 14, 2019

(54) HOLOGRAPHIC DISPLAY SYSTEM AND HOLOGRAPHIC DISPLAY METHOD

(71) Applicant: BOE TECHNOLOGY GROUP CO., LTD., Beijing (CN)

(72) Inventors: Yuxin ZHANG, Beijing (CN); Bingchuan SHI, Beijing (CN); Xinyin WU, Beijing (CN); Yong QIAO, Beijing (CN)

(21) Appl. No.: 15/570,465

(22) PCT Filed: Apr. 24, 2017
(86) PCT No.: PCT/CN2017/081562

§ 371 Date: Oct. 30, 2017

(30) Foreign Application Priority Data
Oct. 28, 2016 (CN) 201610966546.1

(51) Int. Cl. G03H 1/12; G03H 1/22; G03H 1/26

(52) U.S. Cl. CPC G03H 1/12; G03H 2001/0224; G03H 1/2645; G03H 1/2294

(57) ABSTRACT

A holographic display system and a holographic display method are disclosed. By utilizing the shift of at least one of the light source module and the spatial light modulator, a holographic image can be provided to a plurality of stationary or moving observers over a wide range. The holographic display system includes a light source module for generating a coherent beam; a spatial light modulator for generating a holographic image using the coherent beam; a position detecting device for detecting an eye position of at least one observer; and an actuating device capable of shifting at least one of the light source module and the spatial light modulator based on the eye position of the at least one observer, thereby projecting the holographic image to the eye position of the at least one observer.

### RELATED APPLICATIONS

The present application is the U.S. national phase entry of the international application PCT/CN2017/081562, with an international filing date of Apr. 24, 2017, which claims the benefit of Chinese Patent Application No. 201610966546.1, filed on Oct. 28, 2016, the entire disclosures of which are incorporated herein by reference.

### TECHNICAL FIELD

The present disclosure relates to the field of display technology, and more particularly to a holographic display system and a holographic display method.

### BACKGROUND

Conventional holographic images can be observed in a large viewing area. However, in this large viewing area, only holographic image information corresponding to the observer's binocular window is utilized, and the holographic image information in the remaining area is wasted. Therefore, it is possible to calculate only the holographic image information contributing to the binocular window and to track the eyeball position by the eyeball tracing technique. In this way, the observer can see the holographic image, and the computation amount is greatly reduced.

### SUMMARY

The inventor has realized that this “window” technique results in a problem of small viewing angle, and the observer can only observe the holographic image in a fixed viewing window. The holographic image has a limited viewing range and is not suitable for many people to watch.

Therefore, the embodiments of the present disclosure propose a holographic display system and a holographic display method. By utilizing the shift of at least one of the light source module and the spatial light modulator, a holographic image can be provided to a plurality of stationary or moving observers over a wide range.

According to an aspect of the disclosure, an embodiment of the disclosure provides a holographic display system. The holographic display system comprises: a light source module for generating a coherent beam; a spatial light modulator for generating a holographic image using the coherent beam; a position detecting device for detecting an eye position of at least one observer; and an actuating device capable of shifting at least one of the light source module and the spatial light modulator based on the eye position of the at least one observer, thereby projecting the holographic image to the eye position of the at least one observer.

In the embodiment of the disclosure, the actuating device shifts at least one of the light source module and the spatial light modulator based on the eye position of the at least one observer, thereby projecting the holographic image to the eye position of the at least one observer. With the above configuration, in the presence of multiple observers and/or observers in motion, the holographic image can be projected in real time to the eye position of the at least one observer in a time division multiplexing manner, thereby improving the display effect and quality of the holographic image. Moreover, for the optical path of holographic display, by applying the configuration in the embodiment of the present disclosure, additional devices are not required to be inserted into the optical path, avoiding loss of light and the increase in the system complexity.

In certain exemplary embodiments, the holographic display system further comprises a liquid crystal lens array arranged on a light exit side of the spatial light modulator.

The liquid crystal lens array is capable of adjusting the viewing window to the eye position of at least one observer more accurately based on the eye position of the at least one observer (including the distance and azimuth angle of the observer relative to the holographic display system). It will be appreciated by those skilled in the art that a plurality of liquid crystal lens arrays can be used for a plurality of observers.

In certain exemplary embodiments, the actuating device is a three-dimensional actuating device.

With the three-dimensional actuating device, at least one of the coherent light source, the lens and the spatial light modulator can be shifted in three dimensions. When the observer's position (e.g., distance and azimuth angle) with respect to the holographic display system is changed, at least one of the coherent light source, the lens and the spatial light modulator can be shifted by, for example, a three-dimensional actuating device, thereby efficiently and accurately maintaining the display quality of the holographic image for the observer. In contrast, if a single refracting device is used to deflect the light beam in the holographic display system, when the distance of the observer with respect to the holographic display system is changed, in order to ensure the display quality of the holographic image, the parameters such as the focal length of the imaging lens should also be adjusted synergistically, which greatly increases the system complexity.

In certain exemplary embodiments, the actuating device is a piezoelectric actuating device or a microelectromechanical system (MEMS) actuating device.

Piezoelectric actuating device and microelectromechanical system actuating device have advantages such as small size, light weight, low power consumption, high reliability, high sensitivity, easy integration, and so on, and thus can be advantageously applied in holographic display systems.

In certain exemplary embodiments, the holographic display system further comprises: an eye diagram processing device for obtaining a fixation point coordinate of the at least one observer based on a pupil center of an eye of the at least one observer.

The eye diagram processing device can be applied for obtaining a fixation point coordinate of the at least one observer based on a pupil center of an eye of the at least one observer. Therefore, it is possible to more accurately determine the portion of the holographic image most concerned by the observer based on the observer's fixation point coordinate, thereby further reducing the amount of data and the amount of computation for the holographic image.

In certain exemplary embodiments, the light source module comprises a laser light source and a lens arranged on a light exit side of the laser light source.

In certain exemplary embodiments, the laser light source comprises at least a red laser, a green laser, and a blue laser.

In order to achieve color holographic display, for example, a red laser (or a red coherent light source), a green laser (or a green coherent light source), and a blue laser (or a blue coherent light source) can be applied in a time division multiplexing manner to respectively display a red holographic image, a green holographic image and a blue holographic image, so that the observer perceives a color holographic image. Similarly, a light source module can also be implemented using an array of LED light sources including at least a red LED, a green LED and a blue LED. It will be appreciated by those skilled in the art that other color combinations can also be used to generate a color holographic image.

According to another aspect of the present disclosure, an embodiment of the present disclosure provides a holographic display method comprising: generating a coherent beam using a light source module; generating a holographic image using a spatial light modulator and the coherent beam; detecting an eye position of at least one observer; and shifting at least one of the light source module and the spatial light modulator based on the eye position of the at least one observer, thereby projecting the holographic image to the eye position of the at least one observer.

In the embodiment of the disclosure, at least one of the light source module and the spatial light modulator is shifted based on the eye position of the at least one observer, thereby projecting the holographic image to the eye position of the at least one observer. With the above configuration, in the presence of multiple observers and/or observers in motion, the holographic image can be projected in real time to the eye position of the at least one observer in a time division multiplexing manner, thereby improving the display effect and quality of the holographic image. Moreover, for the optical path of holographic display, by applying the configuration in the embodiment of the present disclosure, additional devices are not required to be inserted into the optical path, avoiding loss of light and the increase in the system complexity.

In certain exemplary embodiments, the step of shifting at least one of the light source module and the spatial light modulator based on the eye position of the at least one observer comprises: based on the eye position of the at least one observer, shifting at least one of the light source module and the spatial light modulator in three dimensions.

When the observer's position (e.g., distance and azimuth angle) with respect to the holographic display system is changed, at least one of the coherent light source, the lens and the spatial light modulator can be shifted by, for example, a three-dimensional actuating device, thereby efficiently and accurately maintaining the display quality of the holographic image for the observer. In contrast, if a single refracting device is used to deflect the light beam in the holographic display system, when the distance of the observer with respect to the holographic display system is changed, in order to ensure the display quality of the holographic image, the parameters such as the focal length of the imaging lens should also be adjusted synergistically, which greatly increases the system complexity.

In certain exemplary embodiments, the step of shifting at least one of the light source module and the spatial light modulator based on the eye position of the at least one observer comprises: based on the eye position of the at least one observer, shifting at least one of the light source module and the spatial light modulator using a piezoelectric actuating device or a microelectromechanical system actuating device.

Piezoelectric actuating device and microelectromechanical system actuating device have advantages such as small size, light weight, low power consumption, high reliability, high sensitivity, easy integration, and so on, and thus can be advantageously applied in holographic display systems.

In certain exemplary embodiments, the holographic display method further comprises: obtaining a fixation point coordinate of the at least one observer based on a pupil center of an eye of the at least one observer.

The fixation point coordinate of the at least one observer can be obtained based on a pupil center of an eye of the at least one observer. Therefore, it is possible to more accurately determine the portion of the holographic image most concerned by the observer based on the observer's fixation point coordinate, thereby further reducing the amount of data and the amount of computation for the holographic image.

In certain exemplary embodiments, the holographic display method further comprises: based on the eye position of the at least one observer, projecting the holographic image to the eye position of the at least one observer using a liquid crystal lens array.

The liquid crystal lens array is capable of adjusting the viewing window to the eye position of at least one observer more accurately based on the eye position of the at least one observer (including the distance and azimuth angle of the observer relative to the holographic display system). It will be appreciated by those skilled in the art that a plurality of liquid crystal lens arrays can be used for a plurality of observers.

In certain exemplary embodiments, the step of generating a holographic image using a spatial light modulator and the coherent beam comprises: in a time division multiplexing manner, generating at least a red holographic image, a green holographic image and a blue holographic image using the spatial light modulator and the light source module.

In order to achieve color holographic display, for example, a red laser (or a red coherent light source), a green laser (or a green coherent light source), and a blue laser (or a blue coherent light source) can be applied in a time division multiplexing manner to respectively display a red holographic image, a green holographic image and a blue holographic image, so that the observer perceives a color holographic image. Similarly, a light source module can also be implemented using an array of LED light sources including at least a red LED, a green LED and a blue LED. It will be appreciated by those skilled in the art that other color combinations can also be used to generate a color holographic image.

In certain exemplary embodiments, the holographic display method further comprises: determining a shifting period of at least one of the light source module and the spatial light modulator based on a number of the at least one observer.

The shifting period T of at least one of the light source module and the spatial light modulator can include several (e.g., N) stages P, where N is the number of the at least one observer. For example, the duration of all stages P can be set to be the same. For each stage, P=(S+D), where S is the shifting duration of at least one of the light source module and the spatial light modulator in each shifting period, and D is the display duration of the holographic display system in each shifting period. In order to ensure that the shift of at least one of the light source module and the spatial light modulator cannot be perceived by the observer, switching of at least one of the light source module and the spatial light modulator between the respective operating positions should be accomplished within the visual persistence time (e.g., 0.05-0.2 seconds).

### BRIEF DESCRIPTION OF THE DRAWINGS

FIG. 1 shows a structural schematic diagram of a holographic display system according to an embodiment of the disclosure;

FIG. 2 shows a structural schematic diagram of a holographic display system according to another embodiment of the disclosure;

FIG. 3 shows a structural schematic diagram of a light source according to an embodiment of the disclosure;

FIG. 4 shows a flowchart of a holographic display method according to an embodiment of the disclosure;

FIG. 5 shows a flowchart of a holographic display method according to another embodiment of the disclosure; and

FIG. 6 shows a sequence diagram of a light source operation and a spatial light modulator loading a holographic image data according to an embodiment of the disclosure.

### DETAILED DESCRIPTION OF THE DISCLOSURE

In the following, the technical solutions in embodiments of the disclosure will be described clearly and completely in connection with the drawings in the embodiments of the disclosure. Obviously, the described embodiments are only part of the embodiments of the disclosure, and not all of the embodiments. Based on the embodiments in the disclosure, all other embodiments obtained by those of ordinary skills in the art under the premise of not paying out creative work pertain to the protection scope of the disclosure.

According to an aspect of the disclosure, as shown in FIG. 1, an embodiment of the disclosure provides a holographic display system 100. The holographic display system 100 comprises: a light source module 110 (including a coherent light source 101 and a lens 102 disposed on the light exit side of the coherent light source 101) for generating a coherent beam 104; a spatial light modulator 103 for generating a holographic image 105 using the coherent beam 104; a position detecting device 106 for detecting eye positions (e.g., A and A′ in FIG. 1) of at least one observer; and an actuating device 107 capable of shifting at least one of the coherent light source 101, lens 102 and the spatial light modulator 103 based on the eye position of the at least one observer, thereby projecting the holographic image 105 to the eye position of the at least one observer.

In the embodiment of the disclosure, the actuating device shifts at least one of the light source module and the spatial light modulator based on the eye position of the at least one observer, thereby projecting the holographic image to the eye position of the at least one observer. With the above configuration, in the presence of multiple observers and/or observers in motion, the holographic image can be projected in real time to the eye position of the at least one observer in a time division multiplexing manner, thereby improving the display effect and quality of the holographic image. Moreover, for the optical path of holographic display, by applying the configuration in the embodiment of the present disclosure, additional devices are not required to be inserted into the optical path, avoiding loss of light and the increase in the system complexity.

In the context of the disclosure, each “detecting device” and “processing device” in the embodiments can be realized by a computer (e.g. personal computer) or a combination of a computer and a suitable sensor; the processing of each “detecting device” and “processing device” can be realized e.g. by a processor in the computer. For example, the position detecting device can be implemented using a combination of a camera and a computer; the eye diagram processing device can be implemented using a processor in a computer.

The original holographic image data can be provided via a network or a memory to a processor of a computer that calculates the holographic image data corresponding to the eye position of the at least one observer based on the eye position of the at least one observer. The spatial light modulator uses the calculated holographic image data to display a holographic image, thereby projecting the holographic image to the eye position of the at least one observer.

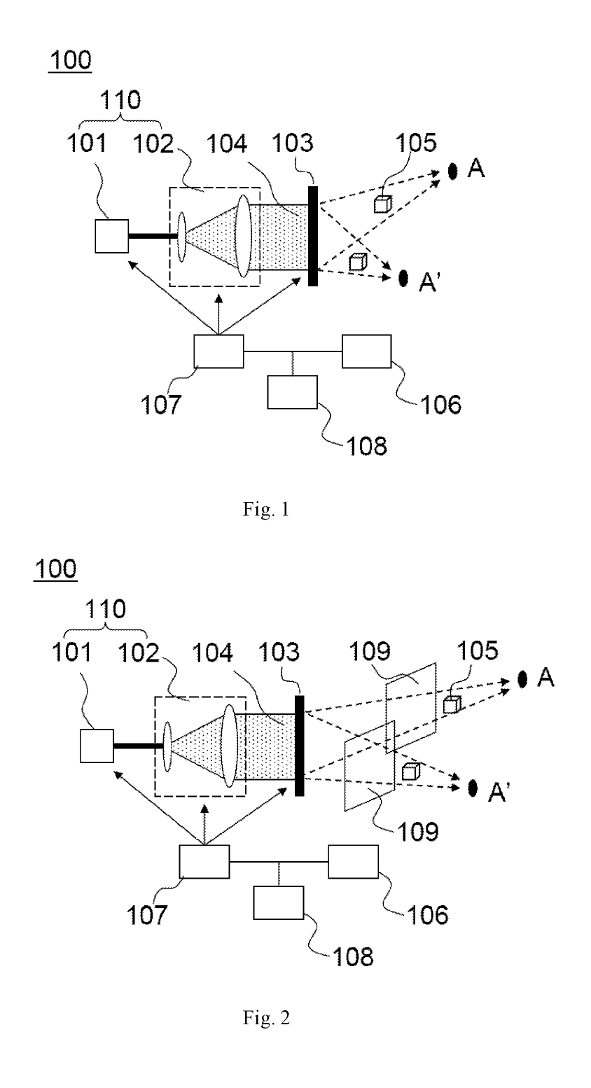

In certain exemplary embodiments, as shown in FIG. 2, the holographic display system 100 further comprises a liquid crystal lens array 109 arranged on a light exit side of the spatial light modulator 103.

The liquid crystal lens array 109 is capable of adjusting the viewing window to the eye position of at least one observer more accurately based on the eye position of the at least one observer (including the distance and azimuth angle of the observer relative to the holographic display system). It will be appreciated by those skilled in the art that a plurality of liquid crystal lens arrays 109 can be used for a plurality of observers.

In certain exemplary embodiments, the actuating device 107 is a three-dimensional actuating device. The actuating device can be arranged to support at least one of the coherent light source, the lens and the spatial light modulator, thereby actuating at least one of the coherent light source, the lens, and the spatial light modulator.

With the three-dimensional actuating device, at least one of the coherent light source, the lens and the spatial light modulator can be shifted in three dimensions. When the observer's position (e.g., distance and azimuth angle) with respect to the holographic display system is changed, at least one of the coherent light source, the lens and the spatial light modulator can be shifted by, for example, a three-dimensional actuating device, thereby efficiently and accurately maintaining the display quality of the holographic image for the observer. In contrast, if a single refracting device is used to deflect the light beam in the holographic display system, when the distance of the observer with respect to the holographic display system is changed, in order to ensure the display quality of the holographic image, the parameters such as the focal length of the imaging lens should also be adjusted synergistically, which greatly increases the system complexity.

In certain exemplary embodiments, the actuating device 107 is a piezoelectric actuating device or a microelectromechanical system actuating device.

Piezoelectric actuating device and microelectromechanical system actuating device have advantages such as small size, light weight, low power consumption, high reliability, high sensitivity, easy integration, and so on, and thus can be advantageously applied in holographic display systems.

In certain exemplary embodiments, as shown in FIG. 1, the holographic display system 100 can further comprise: an eye diagram processing device 108 for obtaining a fixation point coordinate of the at least one observer based on a pupil center of an eye of the at least one observer.

The eye diagram processing device can be applied for obtaining a fixation point coordinate of the at least one observer based on a pupil center of an eye of the at least one observer. Therefore, it is possible to more accurately determine the portion of the holographic image most concerned by the observer based on the observer's fixation point coordinate, thereby further reducing the amount of data and the amount of computation for the holographic image.

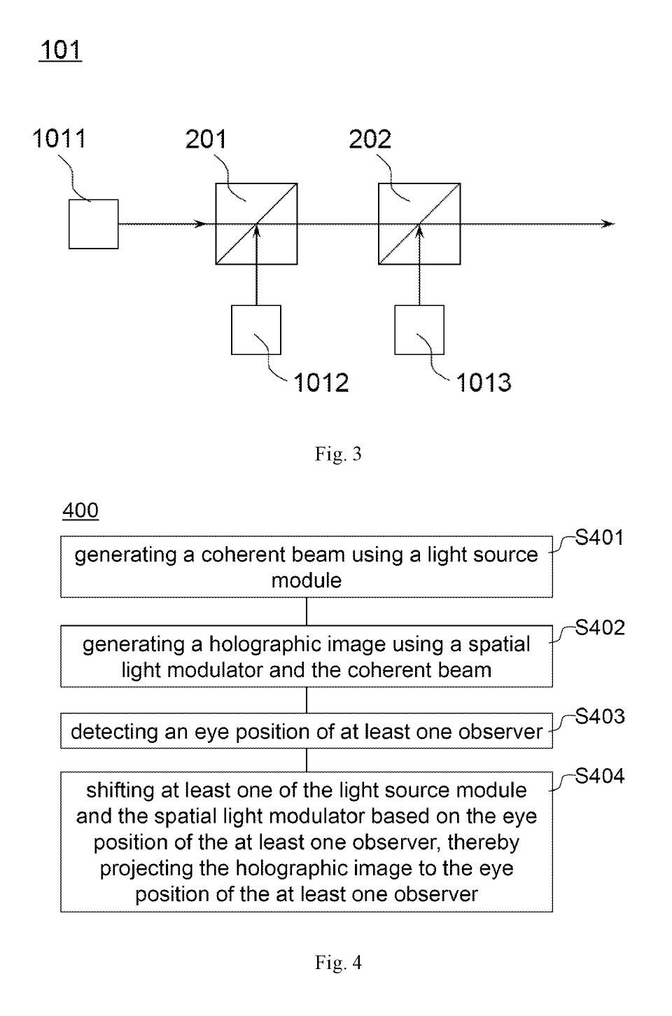

In certain exemplary embodiments, as shown in FIG. 3, the light source module 110 comprises a laser light source 101 and a lens 102 arranged on a light exit side of the laser light source. The laser light source 101 comprises at least a red laser 1011, a green laser 1012, and a blue laser 1013. The light beams respectively emitted from the red laser 1011, the green laser 1012, and the blue laser 1013 can be combined into the same light beam by applying, for example, the beam splitters 201 and 202.

In order to achieve color holographic display, for example, a red laser (or a red coherent light source), a green laser (or a green coherent light source), and a blue laser (or a blue coherent light source) can be applied in a time division multiplexing manner to respectively display a red holographic image, a green holographic image and a blue holographic image, so that the observer perceives a color holographic image. Similarly, a light source module can also be implemented using an array of LED light sources including at least a red LED, a green LED and a blue LED. It will be appreciated by those skilled in the art that other color combinations can also be used to generate a color holographic image.

According to another aspect of the present disclosure, as shown in FIG. 4, an embodiment of the present disclosure provides a holographic display method 400 comprising: (S401) generating a coherent beam using a light source module; (S402) generating a holographic image using a spatial light modulator and the coherent beam; (S403) detecting an eye position of at least one observer; and (S404) shifting at least one of the light source module and the spatial light modulator based on the eye position of the at least one observer, thereby projecting the holographic image to the eye position of the at least one observer.

In the embodiment of the disclosure, at least one of the light source module and the spatial light modulator is shifted based on the eye position of the at least one observer, thereby projecting the holographic image to the eye position of the at least one observer. With the above configuration, in the presence of multiple observers and/or observers in motion, the holographic image can be projected in real time to the eye position of the at least one observer in a time division multiplexing manner, thereby improving the display effect and quality of the holographic image. Moreover, for the optical path of holographic display, by applying the configuration in the embodiment of the present disclosure, additional devices are not required to be inserted into the optical path, avoiding loss of light and the increase in the system complexity.

In certain exemplary embodiments, the step of shifting at least one of the light source module and the spatial light modulator based on the eye position of the at least one observer comprises: based on the eye position of the at least one observer, shifting at least one of the light source module and the spatial light modulator in three dimensions.

When the observer's position (e.g., distance and azimuth angle) with respect to the holographic display system is changed, at least one of the coherent light source, the lens and the spatial light modulator can be shifted by, for example, a three-dimensional actuating device, thereby efficiently and accurately maintaining the display quality of the holographic image for the observer. In contrast, if a single refracting device is used to deflect the light beam in the holographic display system, when the distance of the observer with respect to the holographic display system is changed, in order to ensure the display quality of the holographic image, the parameters such as the focal length of the imaging lens should also be adjusted synergistically, which greatly increases the system complexity. In certain exemplary embodiments, the step of shifting at least one of the light source module and the spatial light modulator based on the eye position of the at least one observer comprises: based on the eye position of the at least one observer, shifting at least one of the light source module and the spatial light modulator using a piezoelectric actuating device or a microelectromechanical system actuating device.

Piezoelectric actuating device and microelectromechanical system actuating device have advantages such as small size, light weight, low power consumption, high reliability, high sensitivity, easy integration, and so on, and thus can be advantageously applied in holographic display systems.

In certain exemplary embodiments, as shown in FIG. 5, the holographic display method 400 can further comprise: (S403′) obtaining a fixation point coordinate of the at least one observer based on a pupil center of an eye of the at least one observer.

The fixation point coordinate of the at least one observer can be obtained based on a pupil center of an eye of the at least one observer. Therefore, it is possible to more accurately determine the portion of the holographic image most concerned by the observer based on the observer's fixation point coordinate, thereby further reducing the amount of data and the amount of computation for the holographic image.

In certain exemplary embodiments, referring to the embodiment illustrated with FIG. 2, the holographic display method can further comprise: based on the eye position of the at least one observer, projecting the holographic image to the eye position of the at least one observer using a liquid crystal lens array.

The liquid crystal lens array is capable of adjusting the viewing window to the eye position of at least one observer more accurately based on the eye position of the at least one observer (including the distance and azimuth angle of the observer relative to the holographic display system). It will be appreciated by those skilled in the art that a plurality of liquid crystal lens arrays can be used for a plurality of observers.

In certain exemplary embodiments, the step of generating a holographic image using a spatial light modulator and the coherent beam comprises: in a time division multiplexing manner, generating at least a red holographic image, a green holographic image and a blue holographic image using the spatial light modulator and the light source module.

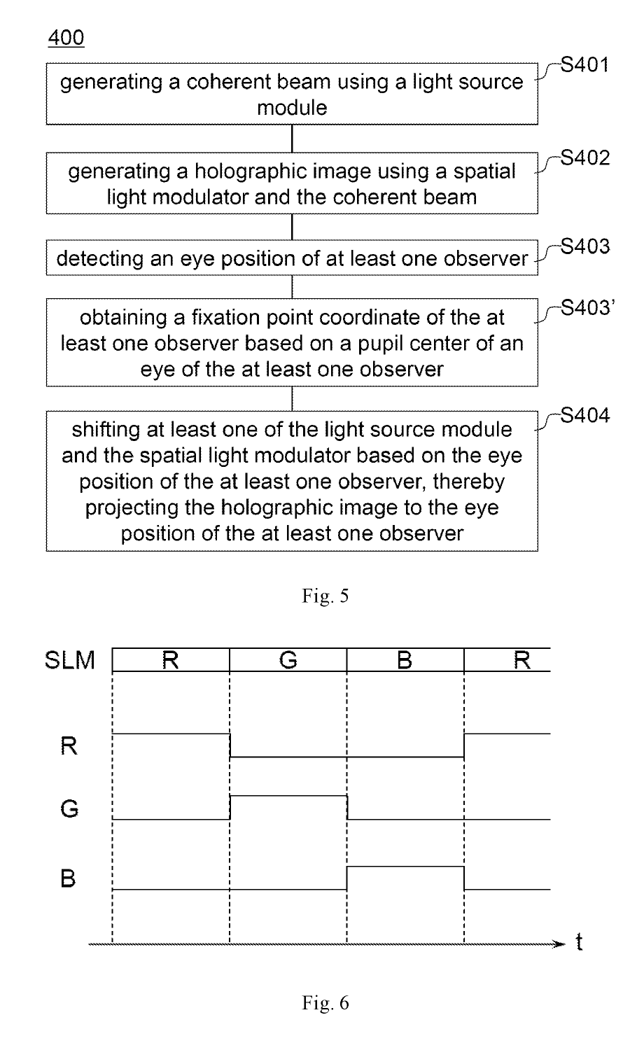

In order to achieve color holographic display, for example, a red laser (or a red coherent light source), a green laser (or a green coherent light source), and a blue laser (or a blue coherent light source) can be applied in a time division multiplexing manner to respectively display a red holographic image, a green holographic image and a blue holographic image, so that the observer perceives a color holographic image. Similarly, a light source module can also be implemented using an array of LED light sources including at least a red LED, a green LED and a blue LED. It will be appreciated by those skilled in the art that other color combinations can also be used to generate a color holographic image. In order to realize color holographic display, as shown in FIG. 6, a sequence diagram of a light source operation and a spatial light modulator loading a holographic image data can be applied. As shown in FIG. 6, a red laser (or a red coherent light source), a green laser (or a green coherent light source) and a blue laser (or a blue coherent light source) emit light alternately. During the laser emission of a certain color, the spatial light modulator SLM loads the holographic image data corresponding to the color, thereby displaying a holographic image of the certain color. In this way, the holographic display device can display holographic images corresponding to the respective colors at a predetermined frequency, so that the observer can observe the color holographic image.

It will be appreciated by those skilled in the art, in order to ensure that the shift of at least one of the light source module and the spatial light modulator cannot be perceived by the observer, the spatial light modulator can be turned off during the execution of the shift; that is, the spatial light modulator blocks the coherent beam during execution of the shift.

In certain exemplary embodiments, the holographic display method further comprises: determining a shifting period of at least one of the light source module and the spatial light modulator based on a number of the at least one observer.

The shifting period T of at least one of the light source module and the spatial light modulator can include several (e.g., N) stages P, where N is the number of the at least one observer. For example, the duration of all stages P can be set to be the same. For each stage, P=(S+D), where S is the shifting duration of at least one of the light source module and the spatial light modulator in each shifting period, and D is the display duration of the holographic display system in each shifting period. In order to ensure that the shift of at least one of the light source module and the spatial light modulator cannot be perceived by the observer, switching of at least one of the light source module and the spatial light modulator between the respective operating positions should be accomplished within the visual persistence time (e.g., 0.05-0.2 seconds).

The embodiments of the present disclosure provide a holographic display system and a holographic display method. At least one of the light source module and the spatial light modulator is shifted based on the eye position of the at least one observer, thereby projecting the holographic image to the eye position of the at least one observer. With the above configuration, in the presence of multiple observers and/or observers in motion, the holographic image can be projected in real time to the eye position of the at least one observer in a time division multiplexing manner, thereby improving the display effect and quality of the holographic image. Moreover, for the optical path of holographic display, by applying the configuration in the embodiment of the present disclosure, additional devices are not required to be inserted into the optical path, avoiding loss of light and the increase in the system complexity.

Apparently, the person skilled in the art may make various alterations and variations to the disclosure without departing the spirit and scope of the disclosure. As such, provided that these modifications and variations of the disclosure pertain to the scope of the claims of the invention and their equivalents, the disclosure is intended to embrace these alterations and variations.

1. A holographic display system, comprising:
a light source module for generating a coherent beam;
a spatial light modulator for generating a holographic image using the coherent beam;
a position detecting device for detecting an eye position of at least one observer; and
an actuating device capable of shifting at least one of the light source module and the spatial light modulator based on the eye position of the at least one observer, thereby projecting the holographic image to the eye position of the at least one observer.

2. The holographic display system according to claim 1, further comprising: a liquid crystal lens array arranged on a light exit side of the spatial light modulator.

3. The holographic display system according to claim 1 or 2, wherein the actuating device is a three-dimensional actuating device.

4. The holographic display system according to claim 1 or 2, wherein the actuating device is a piezoelectric actuating device or a microelectromechanical system actuating device.

5. The holographic display system according to claim 1 or 2, further comprising: an eye diagram processing device for obtaining a fixation point coordinate of the at least one observer based on a pupil center of an eye of the at least one observer.

6. The holographic display system according to claim 1 or 2, wherein the light source module comprises a laser light source and a lens arranged on a light exit side of the laser light source.

7. The holographic display system according to claim 6, wherein the laser light source comprises at least a red laser, a green laser, and a blue laser.

8. The holographic display system according to claim 1 or 2, wherein the light source module comprises an LED light source array; the LED light source array comprises at least a red LED, a green LED, and a blue LED.

9. A holographic display method, comprising:
generating a coherent beam using a light source module;
generating a holographic image using a spatial light modulator and the coherent beam;
detecting an eye position of at least one, observer; and
shifting at least one of the light source module and the spatial light modulator based on the eye position of the at least one observer, thereby projecting the holographic image to the eye position of the at least one observer.

10. The holographic display method according to claim 9, wherein shifting at least one of the light source module and the spatial light modulator based on the eye position of the at least one observer comprises: based on the eye position of the at least one observer, shifting at least one of the light source module and the spatial light modulator in three dimensions.

11. The holographic display method according to claim 9, wherein shifting at least one of the light source module and the spatial light modulator based on the eye position of the at least one observer comprises: based on the eye position of the at least one observer, shifting at least one of the light source module and the spatial light modulator using a piezoelectric actuating device or a microelectromechanical system actuating device.

12. The holographic display method according to claim 9, further comprising: obtaining a fixation point coordinate of the at least one observer based on a pupil center of an eye of the at least one observer.

13. The holographic display method according to claim 9, further comprising: based on the eye position of the at least one observer, projecting the holographic image to the eye position of the at least one observer using a liquid crystal lens array.

14. The holographic display method according to claim 9, wherein generating a holographic image using a spatial light modulator and the coherent beam comprises: in a time division multiplexing manner, generating at least a red holographic image, a green holographic image and a blue holographic image using the spatial light modulator and the light source module.

15. The holographic display method according to claim 9, further comprising: determining a shifting period of at least one of the light source module and the spatial light modulator based on a number of the at least one observer.

16. The holographic display system according to claim 2, wherein the actuating device is a three-dimensional actuating device.

17. The holographic display system according to claim 2, wherein the actuating device is a piezoelectric actuating device or a microelectromechanical system actuating device.

18. The holographic display system according to claim 2, further comprising: an eye diagram processing device for obtaining a fixation point coordinate of the at least one observer based on a pupil center of an eye of the at least one observer.

19. The holographic display system according to claim 2, wherein the light source module comprises a laser light source and a lens arranged on a light exit side of the laser light source.

20. The holographic display system according to claim 2, wherein the light source module comprises an LED light source array; the LED light source array comprises at least a red LED, a green LED, and a blue LED.
